(19) United States
(12) Patent Application Publication
(10) Pub. No.: US 2002/0050035 A1
(43) Pub. Date: May 2, 2002

(54) Tandem burial vault

(76) Inventor: James R. Spicer, Hamilton, OH (US)

Correspondence Address: DAVID S. STALLARD, Wood, Herron & Evans, L.L.P., 2700 Carew Tower, 441 Vine Street, Cincinnati, OH, 45202-2917, US

(21) Appl. No.: 09/978,809

(22) Filed: Oct. 16, 2001

Related U.S. Application Data
(60) Provisional application No. 60/241,175, filed on Oct. 17, 2000.

(51) Int. Cl. A61G 17/00

(52) U.S. Cl. 27/35

(57) ABSTRACT

A tandem burial vault structure comprises two burial vaults of identical structure, each having nesting features for use in connecting one vault over another. A lower chamber in a lower vault is permanently sealed by the upper vault. An image-bearing liner is insertable into each vault.

Applicant claims benefit of the Oct. 17, 2000 filing date of applicant's provisional patent application, U.S. Ser. No. 60/241,175, confirmation no. 4099.

This invention relates to burial vaults and in particular to burial vaults accommodating two or more caskets.

The decreasing supply of burial spaces wherein one casket is buried in each site is troublesome. Increasing use of burial vaults into which caskets are placed has exacerbated the problem, particularly where grave plots, purchased years ago without consideration for the extra space required for such vaults, are now too small to accommodate the earlier planned number of burials. Thus, a site or plot purchased years ago for two, four or six graves, for example, may be too small to accommodate that number of graves where burial vaults are now to be used. Or the sites may be simply forgotten over time, thus resulting in inefficient uses of space.

In order to address this problem, certain attempts have been made to provide for tandem casket burials, where one casket is placed in a double vault atop another casket previously placed in the vault. One example of this is in U.S. Pat. No. 5,746,030. In such a manner, two caskets are placed in a single grave site requiring only a slightly larger “footprint” due to the size of the tandem vault. In that disclosure, a vault tall enough to accommodate one casket on top of another is buried. An intermediate floor is provided above the first casket and a top placed on the upper end of the vault. Thereafter, the top can be removed and a second casket can be lowered onto the intermediate floor and the vault then reclosed by the top.

The use of a unitary vault having a height sufficient for two caskets is awkward. The vaults are heavy, and heavier lifting equipment, like cranes, must be used. In crowded cemeteries, small carts may be used for single casket vaults but a dual sized vault is very cumbersome.

Such a system has several problems. These include the problem of leakage and moisture intrusion into the vault before the top is finally sealed. If the top is sealed over the first casket, it is difficult to reopen. Moreover, the double vault is just that, a double vault. Providers must thus stock both single and double vaults to accommodate these two needs.

In another effort to obtain a tandem burial, a deeper hole is prepared for receiving two separate vaults. The deeper hole is required since two vaults, complete with separate tops, must be accommodated, leaving enough room for backfill over the second vault when it is placed. Such deeper holes present cave-in problems and related efficiency and safety issues.

This invention solves these problems through the use of unique structural vault components. According to the invention, on first interment of a dual interment plan, two identical single casket vaults are nested in sealing relation, one to the other, with a top placed over the empty upper vault. This top may be lightly sealed, or not sealed at all. Since each vault is self-contained, and since the bottom of the upper vault is sealed onto the lower, there is no moisture or leakage into or from the lower casket chamber. On the second interment, the top is uncovered, then removed. The upper chamber defined by the upper vault is then cleaned if necessary. After placement of the second casket, the top is sealed to the mouth of the second vault and the tandem burial is completed.

To facilitate this procedure, each vault is preferably identical to the other and comprises a floor and four walls. Around the outside bottom of each vault is one component of a male/female elongated nesting feature, such as an elongated tongue or an elongated groove.

Where the groove is at the bottom, each side and end wall is provided at its upper edge with an elongated tongue, which extends around the entire upper edge. Thus, one vault can be placed on top of the other with the groove in the bottom of the upper vault nesting over the groove in the upper edges of the side and end walls of the lower vault, in sealing relation. Sealing compounds may be used to permanently seal the upper vault to the lower, with the upper vault and its floor serving as a sealed cover over the lower vault and casket therein. Sealants can be placed around the upper edges of a vault, or can be disposed in the grooves of an upper vault or in the vault top.

In a similar manner the vault top has a corresponding elongated groove along the margin of a lower face for nesting in sealing relation to the elongated tongue around the edges of the side and end walls of the upper vault. After placement of a casket in the upper vault, the top can be sealed over it with appropriate sealing techniques. Alternately, it could be left unsealed.

In this way, a supplier must stock only one type vault. Each can be used alone, with a top, or one can be stacked atop another, sealing that lower chamber so created, and thereafter accommodating a second casket in the upper vault chamber. Likewise, multiple vaults in excess of two could be used where desired. Moreover, the invention requires handling of only a single vault at any time, eliminating the handling difficulties presented by heavy, unitary double-sized vaults.

Moreover, where two vaults are used, and even where it is decided to use two separate vaults, each with its own top, the hole necessary to accommodate either configuration is not so deep and was required with two vaults of prior designs and their relatively thick tops. Either two vaults with one top according to the invention, or two vaults with their own tops according to the invention require only shallower holes.

In another aspect of the invention, while the interior surfaces of the vaults may be painted or coated, it is desirable to provide an appropriate decorative appearance to the interior of the vault. For example, in some instances, it may be desirable to decorate the vault interior with a scene or imagery remindful of the decedent's life or interests. Or, it may be desirable to decorate the vault interior with simple, peaceful imagery such as a religious, forest, sunset or sea scene or the like.

Nevertheless, the provision of such decoration, such as by painting or coating the vault service is expensive and time consuming due to its custom nature.

Accordingly, the invention further contemplates a system and apparatus by which standard or customized imagery can be easily and relatively inexpensively deployed within a vault. To this end, the invention includes a liner for the vault, the liner housing an interior surface provided with desired imagery and being prepared as a separate component thereof. Preferably, the liner is made from a sheet of foldable synthetic material, such as a polymer, onto which a scene or desired imagery is produced by any suitable technique, itself not a part of this invention. This can be accomplished, for example, by known photographic printing, projection, reproduction or other technologies. Stock imagery can be used or a custom image supplied by the family of the decedent and can be reproduced on the liner.

It is not necessary for a provider to stock liners with the entire imagery inventory. Rather, liners can be ordered from or provided at the same time the vault is selected, produced and shipped to the funeral home, burial site or vault provider within a short time. Liners can be stocked and sent stacked, or single liners rolled and shipped in a tube.

The liner blanks are preferably supplied in a sheet or web form, and scored for folding into a boxlike shape to fit into a vault. Upper edge margins of liner portions, corresponding to end and side panels of the vault, extend over at least part of the top edges of the vault and are sealed there when a top or an upper vault is sealed thereon.

The excess sheet material of the liner is simply folded over the end panels and held there by adhesive or tape. Two-sided tape or other adhesive may be applied to the outer surfaces of the liner to secure it to the vault. In this manner, the liner can be easily folded and assembled into the vault prior to disposition of the casket therein, and desirable imagery is thus provided on the vault surface.

The figures, illustrate details of the invention.

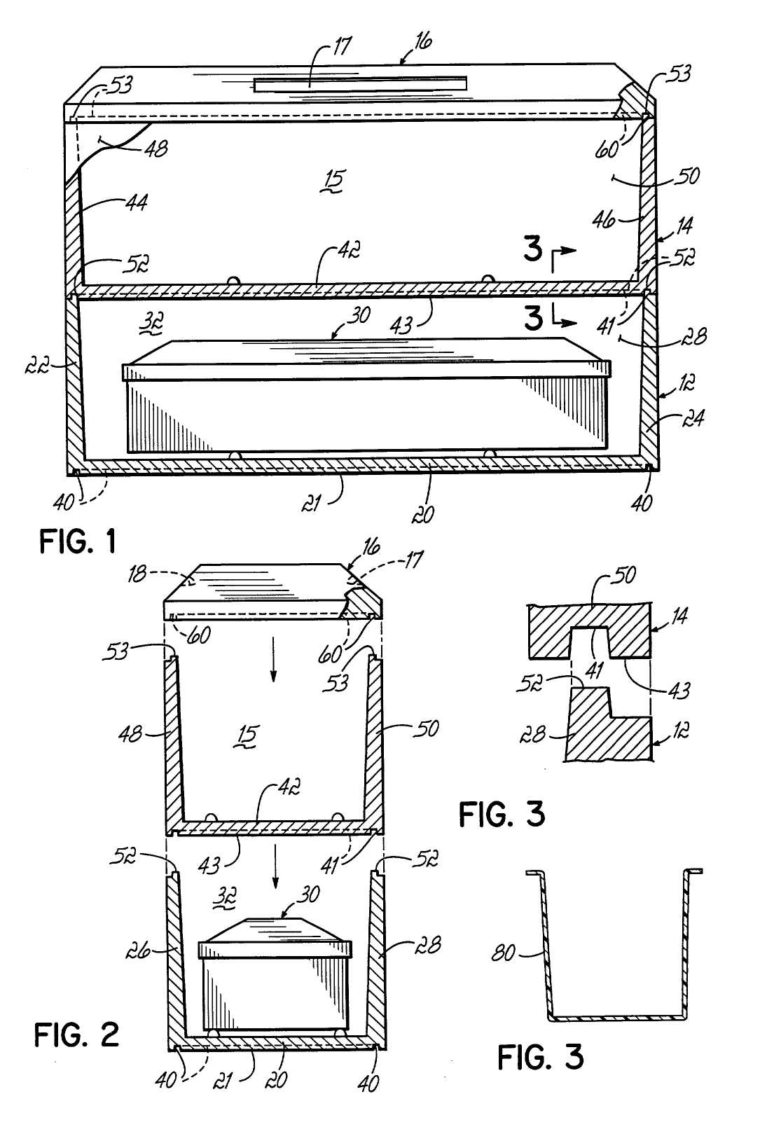

FIG. 1 is an elevational view in partial cross-section showing a tandem vault system with an upper vault placed on a lower vault and a top for the upper vault, only one casket being shown;

FIG. 2 is an end view in partial cross-section of the invention of FIG. 1, but with the lower and upper vaults and top separated for clarity;

FIG. 3 is an expanded cross-sectional detail of the elongated groove/tongue engagement of vault-to-vault and of top-to-vault taken along lines 3-3 of FIG. 1;

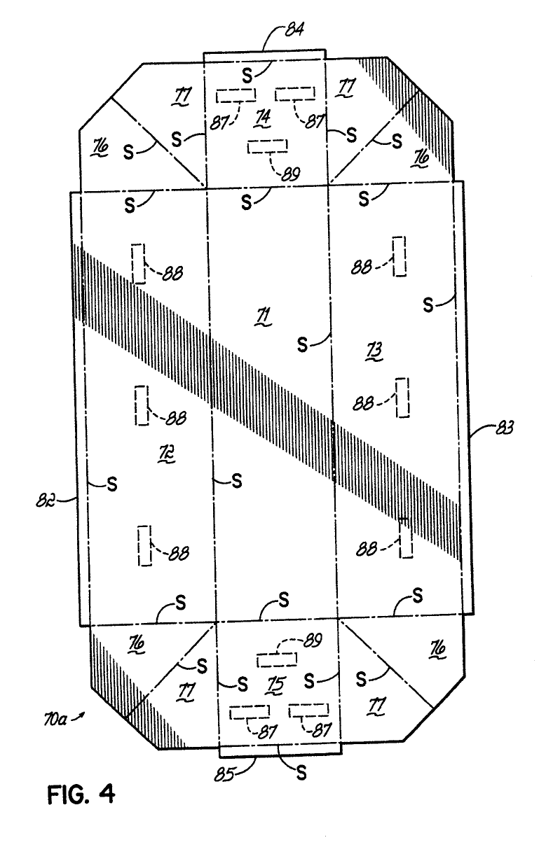

FIG. 4 is a layout plan view of a vault liner according to the invention;

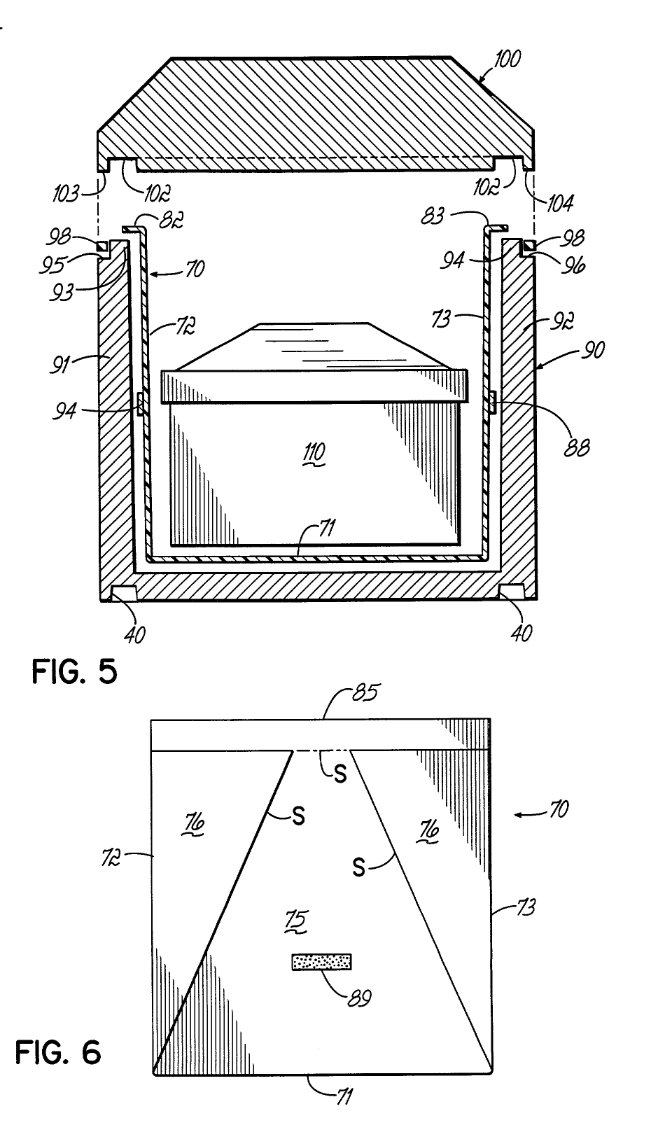

FIG. 5 is a cross sectional view of the vault of the invention showing a liner in place and with a modified vault edge;

FIG. 6 is an end view of a liner of the invention;

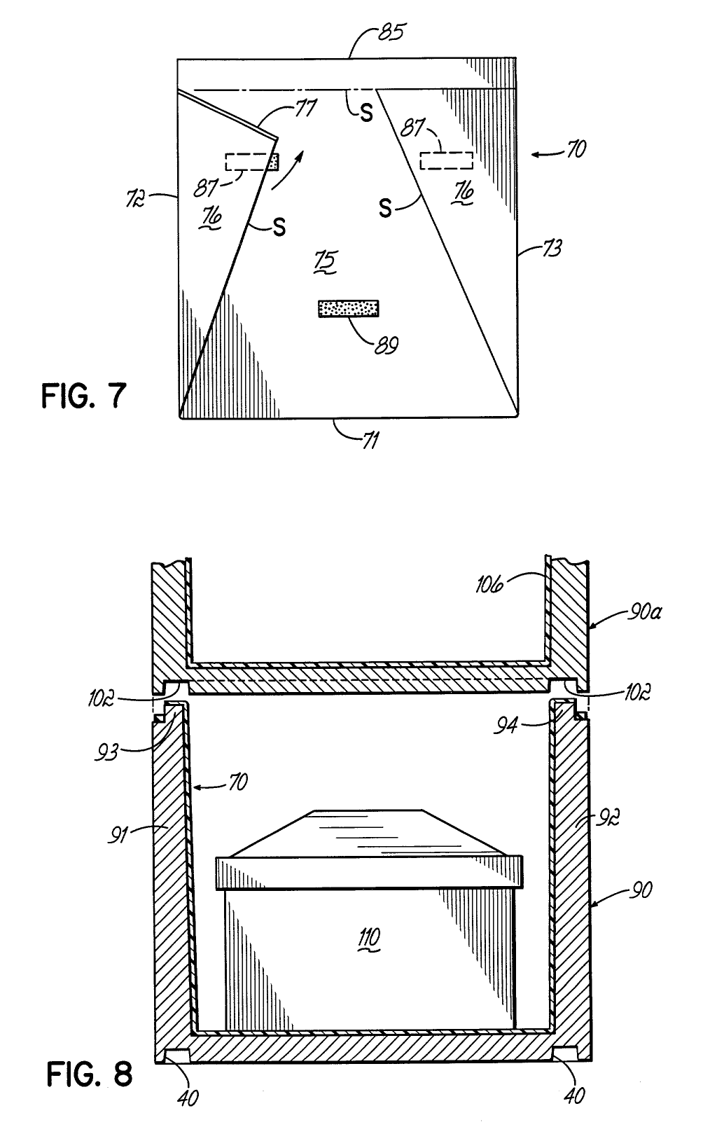

FIG. 7 is an end view of a partially folded liner of the invention;

FIG. 8 shows a modified tandem vault structure, with liner, according to the invention; and

FIG. 9 shows a modified liner form according to the invention.

In FIG. 1, tandem vault system 10 is illustrated and comprises lower vault 12, upper vault 14, and top 16. Vault 12 includes a floor 20, end walls 22, 24 and side walls 26, 28. A casket 30 is placed in lower vault chamber 32. An elongated groove 40 is oriented around the lower face 21 of floor 20 proximate lower ends of end walls 22, 24 and side walls 26, 28.

Upper vault 14 includes a floor 42, end walls 44, 46 and side walls 48, 50. An elongated groove 41 is disposed around lower face 43 of floor 42 proximate lower ends of end walls 44, 46 and side walls 48, 50. Floor 42 and walls 44, 46, 48, 50 define an upper burial chamber 15.

An elongated tongue 52 is disposed on the upper edges of end walls 22, 24 and side walls 26, 28 of lower vault 12. A similar elongated tongue 53 is disposed on upper edges of end walls 44, 46 and side walls 48, 50 of upper casket 14.

As shown in FIG. 3, groove 41 of vault 14 nests over tongue 52 of vault 12 to lock the vaults together. A sealant compound can be used to secure and seal them so chamber 32 in vault 12 is fully sealed.

Groove 40 in the lower vault is unused in this configuration of two tandem vaults. Nevertheless, it will be appreciated that each vault is essentially identical to the other, and that more than two could be stacked, both for ease of pre-use storage, and for interment.

Top 16 is provided with an elongated groove 60 which corresponds and is nestable with tongue 53 of upper vault 14 in tandem configuration. Alternately, top 16 can be used with a single lower vault 12, nesting over tongue 52 thereof, where a single burial chamber 32 may be desired. The top 16 can be sealed to its associated vault with any appropriate sealing technique. It will be appreciated that a variety of tongue and groove or other interconnecting structures can be used to connect a top to a vault, or an upper vault to a lower vault.

In addition, two sort elongated grooves 17, 18 are disposed in top 16 to accommodate lifting of the top by a tong-like attachment (not shown) on a lifting apparatus for handling. Tongs, operating like pinchers, engage the grooves 17, 18 to lift or lower the top 16. Alternately, lift hooks could be secured to the top 16.

Each vault can be made of natural or man-made materials, including but not limited to concrete, concrete products, plastic, plastic products or other synthetic materials, metals or metal products or combinations thereof and can be lined or unlined. The vaults can be molded of any suitable materials, such as the above materials.

Each vault is manufactured to specific sizes and specifications as needed, with each vault in the same size range essentially identical so the upper and lower vaults and tops are interchangeable.

In the alternative, the vaults can be made of insulated panels, for example, of the type having a core of foamed plastic and inner and outer facings of mesh reinforced cementitious panels of the type disclosed in U.S. Pat. No. 5,992,110 showing such insulated panels. See also U.S. Pat. Nos. 3,284,980 and Re. 32,037 relative to components of such insulated panels and manufacturing thereof. Such three patents are expressly herewith incorporated by reference. Such panels can be prefabricated and shipped to local distribution points where they are assembled, joined, glued and sealed together to form a watertight vault when closed with a top or with an upper vault.

However made, the edges and bottom of the vaults can use the specific tongue, lip and groove construction noted above for interconnecting one vault to another, or a top to a vault, or can use any other suitable interconnecting construction or other placement or configuration of the interlocking grooves and lips.

Accordingly, an upper vault is used to seal over the lower vault to finish and seal the lower chamber 32 at the time of interment of casket 30 therein. The upper chamber 15 may remain empty, covered by top 16, until the second interment of a casket therein.

Turning now to FIGS. 4-7, a vault liner 70 preferably bearing a desired image or design (not shown) is developed as a flat liner sheet 70a. Sheet 70a is made of any suitable image bearing material, such as a polymer, but is not limited thereto. Sheet 70a can be a plain color, or translucent or transparent, but is preferably provided with an image.

Sheet 70a is relatively rigid, as opposed to being flimsy, and is scored along the score lines S shown to provide bottom 71, side 72, 73 and 3nd 74, 75 panels. Gusseted panels 76, 77, for example, at each corner between the side and end panels are eventually folded over the end panels 74, 75 when the sheet 70a is folded into a liner configuration 70 (FIG. 7). Side panels 72, 73 have respective margins 82, 83 extending along the edges thereof. End panels 74, 75 have respective margins 84, 85. Margins 82-85 are defined also by score lines S.

Turning now to FIGS. 6 and 7, the liner sheet 70a is folded into a vault or boxlike configuration by folding the panels 71-75 along score lines S, and by folding gusset panels 76, 77 along score lines at the edges of respective side and end panels. The liner 70 is thus in the form of a leakproof box, open at its top. Panels 76, 77 eventually lie adjacent each other and are folded back onto an end panel, such as end panel 75 (FIG. 7).

It will be appreciated that all respective adjacent edges of said side end and bottom panels are integrally joined together.

To hold the gusset panel 76, 77 in place, and thus form the liner 70, two-sided tape 87 or any other suitable adhesive can be oriented on the outer surface of the end panels 74, 75 as illustrated in FIG. 7. Two-sided tape 88 can be disposed on the outer surface of side panels 72, 73 and two-sided tape 89 can be disposed on the outer surface of end panels 74, 75, all to hold the liner in place on the vault surface.

Turning now to FIG. 5, it will be appreciated that the vault 90 is similar to the vaults 12, 14, described above, but has a modified lower face and modified upper edges of its walls. Upper edges of side walls 91, 92 have an extended lip or tongue 93, 94. Shoulders 95, 96 are thus defined and constitute sealing surfaces to a sealing gasket 98, such as an asphalt sealing strip or any other suitable sealants.

The bottom face 101 of vault top 100 (as well as the bottom face of any upper vault to be placed on vault 90) is provided with a groove 102 sized and oriented to interface with lips 93, 94 and liner 70. The top 100, or bottom of any upper vault has a sealing surface 103, 104 cooperating with sealant 98. Of course, lips 93, 94, groove 102, sealant 98 and surfaces 103, 104 are preferably, respectively, continuous.

Margins 82, 83 respectively extend over the respective lips 93, 94 as shown in FIG. 5, the end wall margins 84, 95 likewise extend over similar lips of the end walls of the vault. When top 100, or any suitable upper vault is sealed to vault 90, the groove 102 is fitted over the lower vault edges. The top of the vault seals to sealant 98 and groove 102 may be sized to tightly engage liner 70 and margins 82-85.

Once folded, liner 70 is inserted into a vault, such as vault 90, and held in place by tape. A casket 110 is lowered into the vault either before or after the vault is lowered into the ground. The margin 82-85, which may also bear appropriate imagery or portions thereof, provide a finished edge at the upper edges of the vault. The top 100 or any upper vault can then be sealed to vault 90 (or 90a when the liner is used in an upper vault).

When using an upper vault 90a (FIG. 8), it will be appreciated that it is not necessary to unseal the lower vault chamber, it being preferable that the upper vault 90a is purchased and sealed to lower vault 90 at the time a casket is interred in vault 90. It will also be appreciated that an entirely different scene or image may be applied to an upper liner 106 when the upper vault 90a is used.

In another alternate liner format, the liner 80, as illustrated in cross-section of FIG. 9, can be preformed, for example, in final box-like shape in an injection or blow-molded process, or other thermo-forming process, in the final open top rectangular shape for use. A plurality of such liners can be stacked in nested form for shipping or for storage. Color or other decorating or imaging can be applied by any suitable process. This preformed liner can be inserted into a vault, all as described above.

Accordingly, not only does the invention provide an improved and advantageous tandem vault structure, but it also provides easy to use, inexpensive imagery for decoration of a vault interior.

I Claim:

1. A tandem burial vault comprising:
a lower vault,
an upper vault,
a top,
said upper vault sealable over said lower vault to define a sealed chamber for a casket in the lower vault and said top being sealable to said upper vault upon interment of another casket therein.

2. A vault as in claim 1 wherein each vault comprises a first component of a nesting structure at an upper position thereon and a second corresponding component of a nesting structure at a lower position thereon, said first and second components of respective vaults nesting together when one vault is stacked on top of another.

3. A vault as in claim 2 wherein said top includes a second corresponding component of a nesting structure for nesting with a first component of a nesting structure on a vault.

4. A vault as in claim 1 wherein said upper vault is permanently sealed to said lower vault after a casket is placed in the lower vault and before a casket is placed in the upper vault.

5. A vault as in claim 2 wherein said first component of said nesting structure comprises a tongue and said second corresponding component comprises a groove.

6. A vault as in claim 2 wherein said nesting structure components interlock and further comprising a sealing gasket disposed proximate said components for sealing said vaults together.

7. A vault as in claim 1 further including a liner disposed in said vault, said liner comprising end, side and bottom panels.

8. A vault as in claim 7 wherein said liner comprises margin portions disposed between an upper and tower vault.

9. A vault as in claim 3 further including a liner in said vault, said liner having margin portions disposed between said top and a vault.

10. A liner for a burial vault comprising end, side and bottom panels and an inner surface of at least one of said panels bearing an image.

11. A liner as in claim 10 wherein said liner is developed as a flat sheet.

12. A liner as in claim 10 wherein said side, end and bottom panels are integrally joined together at all respective adjacent edges.

13. A liner as in claim 10 wherein said side and end panels comprise margins along respective upper edges thereof, said margins extending at angles greater than zero degrees from said respective panels wherein said liner is disposed in a burial vault.

14. A liner as in claim 10 further comprising gusset panels disposed between respective proximate edges of said side and end panels and integrally joining said side and end panels.

15. A liner as in claim 14 wherein said gusset panels are folded over on respective ones of said end panels, when said liner is erected to fit into a vault.

16. A liner for a burial vault, said liner having bottom, end and side panels, and a gusset panel between said end and side panels, said end and side panels having margins for selective disposition between two vaults or between a vault and a vault top.
